(19) United States
(12) Patent Application Publication
(10) Pub. No.: US 2026/0285450 A1
(43) Pub. Date: Sep. 24, 2026

(54) A Modular Transportable Nuclear Power Plant

(71) Applicant: Energie propre Prodigy Ltee / Prodigy Clean Energy Ltd., Montreal (CA)

(72) Inventors: Mathias TROJER, Brookline, MA (US); Marcel DEVOS, Oxford Station (CA); Nathaniel Richard BRUNS, Windham Centre (CA); Pawel Kamil TROCKI, Ancaster (CA)

(21) Appl. No.: 19/469,081

(22) PCT Filed: Mar. 29, 2024
(86) PCT No.: PCT/US2024/022144

§ 371 Date: Sep. 25, 2025

Related U.S. Application Data
(60) Provisional application No. 63/456,032, filed on Mar. 31, 2023.

(51) Int. Cl. B63B 35/44; B63B 77/10; G21C 1/32; G21C 13/024; G21C 15/18; G21C 21/00; G21D 1/02; G21F 5/14

(52) U.S. Cl. CPC B63B 35/44; B63B 77/10; G21C 1/32; G21C 13/024; G21C 15/18; G21C 21/00; G21D 1/02; G21F 5/14; B63B 2035/4446

(57) ABSTRACT

A transportable nuclear power plant includes a housing, an outer barrier, forming at least a first part of the housing, a weather shield connected to the outer barrier, forming at least a second part of the housing, a nuclear systems compartment defined within the housing, wherein the nuclear systems compartment is adapted to contain at least one small modular nuclear reactor, a conventional-process compartment defined within the housing, wherein the conventional-process compartment is adapted to contain at least one power generator capable of converting energy from the at least one small modular nuclear reactor into electricity; and a support compartment defined within the housing, wherein the support compartment is adapted to contain at least one system supportive of at least one of the small modular nuclear reactor and the power generator.

### CROSS-REFERENCE TO RELATED APPLICATIONS

This application relies for priority on U.S. Provisional Patent Application Ser. No. 63/456,032, filed on Mar. 31, 2023, the content of which is hereby incorporated by reference in its entirety.

### FIELD OF THE INVENTION

The present invention relates to the deployment of small modular reactors (SMRs).

### BACKGROUND

The global need for energy sources that are sustainable, low-cost, produce low carbon emissions, and have a high capacity factor is growing rapidly. This need is particularly acute in remote, off-grid regions where energy is required to support enterprises that extract and process natural resources such as ores, oil, and gas. For example, such enterprises must produce their own power, and hitherto have typically done so by powering diesel generators using fuel imported by truck, ship, or even air.

Various novel nuclear power plant designs, including some that incorporate small modular reactors (SMRs), can meet this need while overcoming the drawbacks of earlier nuclear plants. Many SMRs are small enough to be transported securely to locations where traditional construction practices are not practical or economic: such as remote or congested coastal sites.

All SMRs are conservatively assumed to be vulnerable to malicious attack, accidents, and natural forces and have potential to result in unacceptable releases of radiological or hazardous substances to the environment. It is therefore required that novel designs be created to integrate effectively with SMR structures, systems and components (SSCs), house these SSCs securely and be installed flexibly and economically in either remote, off-grid locations or grid-connected locations. Such designs should be robust against mechanical failure, malicious attack, human error, and natural disasters, including seismic events and tsunamis. They should avoid the high costs and decadal construction times that have persistently plagued large, one-off nuclear plants and provide in-depth safety by design for their operators, the environment, and the public.

A need thus exists for methods and systems that standardize the design and construction of transportable nuclear power plants (TNPPs), especially for remote deployments; exploit the potential of modular manufacturing as well as marine, overland, or aerial transport for rapid, flexible delivery of system components, including SMRs, to an installation site; are capable of either marine coastal deployment or terrestrial deployment; offer high radiological safety as an integral function of their structure; minimize site-specific bespoke engineering costs; and realize other advantages of TNPPs.

### SUMMARY

Provided herein are methods, systems, components, and the like that enable the modular manufacture, transport, deployment, fueling, and commissioning of a transportable nuclear power plant (TNPP). In various embodiments, the TNPP is a structure assembled at a factory site (e.g., shipyard) qualified for manufacturing and testing commensurate with quality, safety and security requirements. The TNPP also may be assembled at the site of service from a number of standardized, modular components and house one or more small modular reactors (SMRs) stationed within a dedicated internal structural compartment, herein termed the nuclear systems compartment, that is structurally and functionally isolated from one or more additional structural compartments comprised by the TNPP. Elements of a nuclear island, including reactors and power conversion modules (e.g., turbine-generators), are preferably contained within the nuclear systems compartment of the TNPP. The additional structural compartments are dedicated to functions including, but not limited to, reactor control, electrical generation, heat dissipation, water storage, security, and incoming/outgoing power distribution machinery. The structural components of the TNPP are preferably designed for transportability, modular assembly, and ready disassembly during decommissioning of the TNPP. In various embodiments, the TNPP comprises some or all elements of a nuclear power station (e.g., reactors, turbines, generators, control room, laboratories, auxiliary systems, fuel handling systems, security systems, administration, and living facilities, etc.) and preferably constitutes a free-standing source of electrical and/or thermal energy that can function for a long specified time without connection to a supply of off-site power. Other co-generation functions provided by the TNPP in various embodiments include, but are not limited to, medical isotope production, hydrogen production, synthetic fuel production, steam production, process heat for mining, and heat for aquaculture or agriculture.

The two or more compartments of the TNPP are preferably equipped with independent air-circulating systems and are otherwise structurally divided and isolated so as to prevent spread of radioactive contamination within the nuclear systems compartment or into the non-nuclear compartments. In various embodiments, the TNPP comprises three major compartments, (1) a first compartment (a.k.a. the nuclear systems compartment) that houses and rigorously contains sources of radiological contamination, (2) a second compartment (a.k.a. the conventional-process compartment) that houses power-conversion, control of SMRs and other systems, and other functions of high priority for the safe operation of the TNPP, and (3) a third compartment (a.k.a. the support compartment) that houses offices, water storage, and other functions of relatively low priority for the safe operation of the TNPP. The three TNPP compartments are, in various embodiments, either combined into a single structure, maritime or terrestrial, or realized as two or more distinct structures. Additional gear (e.g., switchyard, heat-rejection equipment) may be located in one or more additional structures or areas, or upon a roof or upper deck of the TNPP.

Preferably, the one or more SMRs comprised by the TNPP are stationed within protective cells (herein termed reactor sub-compartments) that are comprised by the nuclear systems compartment. Also in various embodiments, the TNPP comprises: (1) one or more three-dimensionally layered protective structures that partly surrounds at least the nuclear systems compartment of the TNPP and supports reliable performance of required SMR SSCs important to safety, security and non-proliferation when the facility is challenged by a range of postulated external and internal events as well as statutory threat scenarios such as aircraft impacts, and (2) one or more protective outer structures, herein termed the weather shield, that serves functions such as but not limited to shedding snow loads, minimizing wind load, and diversion and energy dissipation of forces from external impacts. In embodiments where the TNPP is realized as a cluster of two or three distinct structures, each structure will preferably have its own protective outer structures to reduce potential for multiple facility accident progressions.

The TNPP is agnostic regarding the design of the SMRs it contains; that is, the TNPP can accommodate any of a number of SMRs or other portable reactor designs, present and future. Although the term “SMR” is used herein, it will be understood that this usage refers to any prefabricated, relocatable form of reactor, with no restriction to any particular reactor design, coolant composition, nuclear fuel composition, or to other variations of nuclear heat generation found in present or future nuclear reactors, including both fission and fusion reactors.

Preferably, standardized steam (or other heat transfer gases or fluids), electrical, and control interfaces connect the nuclear SMRs within the nuclear systems compartment to systems in other compartments of the TNPP. The nuclear systems compartment thus constitutes a “black box” within the TNPP which, in various embodiments, produces steam that is converted to electrical power in a non-nuclear compartment of the TNPP and which may also provide heat for direct applications (heating, industrial process heat, etc.). In various embodiments, the TNPP also comprises battery and/or other energy-storage or backup energy sources that enable it to assure the safety of personnel during reactor shutdown and to cold-start its SMRs without reliance on off-site power.

The TNPP is, in some embodiments, fabricated at a terrestrial installation site from a set of standardized components and modules all designed for portability, on-site assembly and efficient decommissioning. In some other embodiments, the TNPP is assembled at a shipyard and transported overwater to a coastal deployment site.

Arrangements of fissile materials (nuclear fuel) may be configured by a supplier as distinct fuel assemblies or as ‘factory-fueled and sealed’ transportable reactor modules. In either case, they are preferably installed in the TNPP after the TNPP is assembled at or delivered to its operational site. In the first embodiment, nuclear fuel is delivered to the TNPP, installed in the reactor sub compartment by fuel-handling equipment integral to the TNPP, and fueled as part of the commissioning process. In the second embodiment, the transportable reactor module is delivered to the TNPP, installed in the reactor sub compartment by a combination of reactor module handling equipment integral to the TNPP and provided by the reactor supplier. The TNPP comprises provisions for installing, removing fissile materials, and in some embodiments provisions for securely and safely managing fresh and/or spent nuclear fuel. All embodiments include provisions, in addition to those included in the SMR design, to enable independent safeguards verification activities by the International Atomic Energy Agency (IAEA).

Various embodiments of the invention realize a number of advantages over the prior art for creating nuclear power stations. These advantages include but are not limited to: (1) self-sufficient TNPP capability to supply power to a local microgrid or other consumer without mandatory connection to offsite power, (2) a robust, multiple nested barrier structural approach that performs at least as effectively as the prior art but at a lower cost and without a requirement that the structures be constructed at the site, (3) reduced lifecycle costs, including operation and maintenance through early incorporation of features that address operability, security, non-proliferation, waste management, and future decommissioning, and/or (4) reduction of site preparation, construction, commissioning and decommissioning activities that require large and costly workforces by: moving key activities into a central and controlled manufacturing/decommissioning facility, and delivering/removing a completed structure to or from the deployment site.

Various embodiments of the invention can provide secure, reliable power in remote locations, as for example extractive industrial operations in the Arctic, in a manner not practically or economically providable by nuclear power plants built according to the prior art.

These and other distinguishing aspects of embodiments of the invention, along with various advantages of embodiments, will be clarified hereinbelow with reference to the Figures.

### BRIEF DESCRIPTION OF THE FIGURES

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1A depicts an SMR reactor module in a transport cask and is representative of any large, delivered component.

FIG. 1B depicts a cross-sectional view of an SMR reactor module in a transport cask and is representative of any large, delivered component.

FIG. 2A depicts an energy distribution system supplied by a TNPP stationed on land.

FIG. 2B depicts energy distribution system supplied by a TNPP stationed in water.

FIG. 3A depicts a cross-sectional, side view of an illustrative TNPP as deployed in a marine environment.

FIG. 3B depicts a cross-sectional, top view of the TNPP of FIG. 3A.

FIG. 3C depicts yet another cross-sectional, end view of the TNPP of FIG. 3A.

FIG. 4A depicts a first stage of the delivery of an SMR module to a TNPP.

FIG. 4B depicts a second stage of the delivery of an SMR module to a TNPP.

FIG. 5A depicts a first compartment of a TNPP.

FIG. 5B depicts a second compartment of a TNPP.

FIG. 5C depicts a third compartment of a TNPP.

FIG. 5D depicts an upper deck of a TNPP.

### DETAILED DESCRIPTION OF THE FIGURES

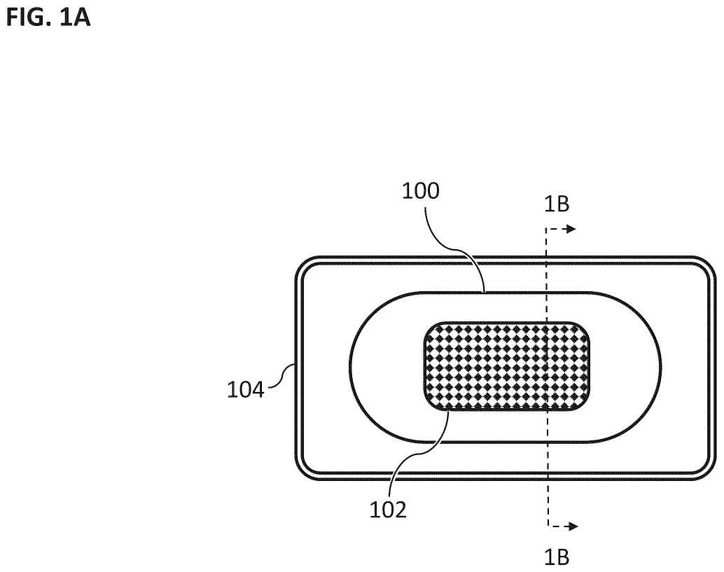

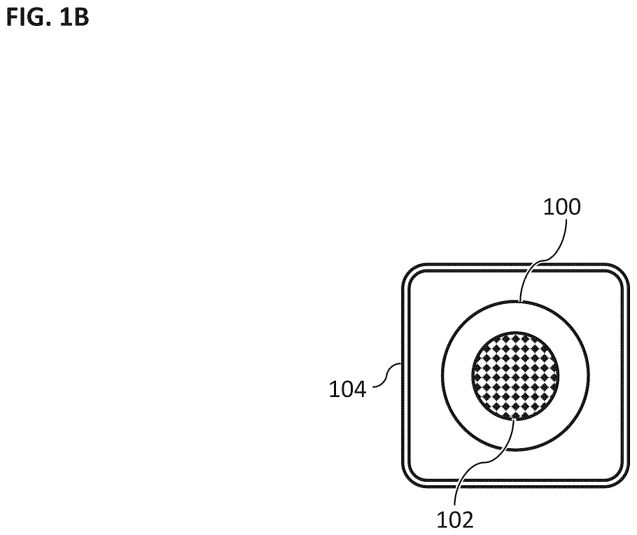

FIG. 1A schematically depicts in longitudinal vertical cross-section an illustrative small modular reactor module (SMR) 100 such as is comprised by a TNPP according to various embodiments of the invention. In this instance, the SMR module 100 comprises a power-generating core 102 and is encased in a protective transport cask 104. In other instances, a module may contain other SMR equipment as required for use in the facility. The power-generating core 102 may contain a load of nuclear fuel during transport of the SMR module 100, or nuclear fuel may be transported to the TNPP's site of service separately from the SMR module. Together, the SMR module 100 and its transport cask 104 are of small enough size and mass to be transportable over long distances by one or more conventional transport systems, e.g., truck, ship, or heavy-lift aircraft. In various embodiments of the invention, as shall be clarified with reference to other Figures herein, one or more SMR modules, each within a cask such as that depicted in FIG. 1, is transported to the TNPP's site of service and there installed within the TNPP.

FIG. 1B depicts the SMR module 100, core 102, and cask 104 of FIG. 1A in transverse cross section at the broken line 1B-1B in FIG. 1A.

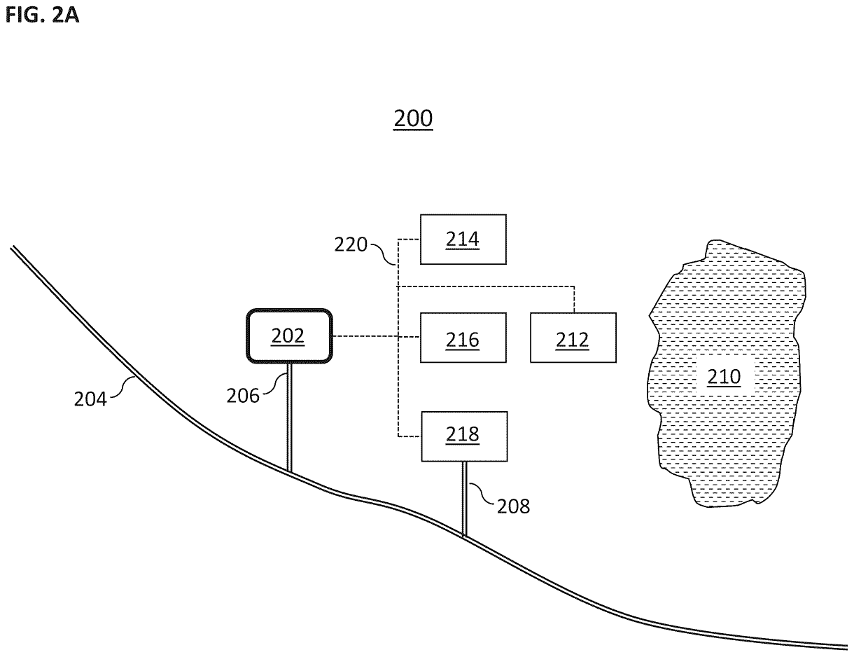

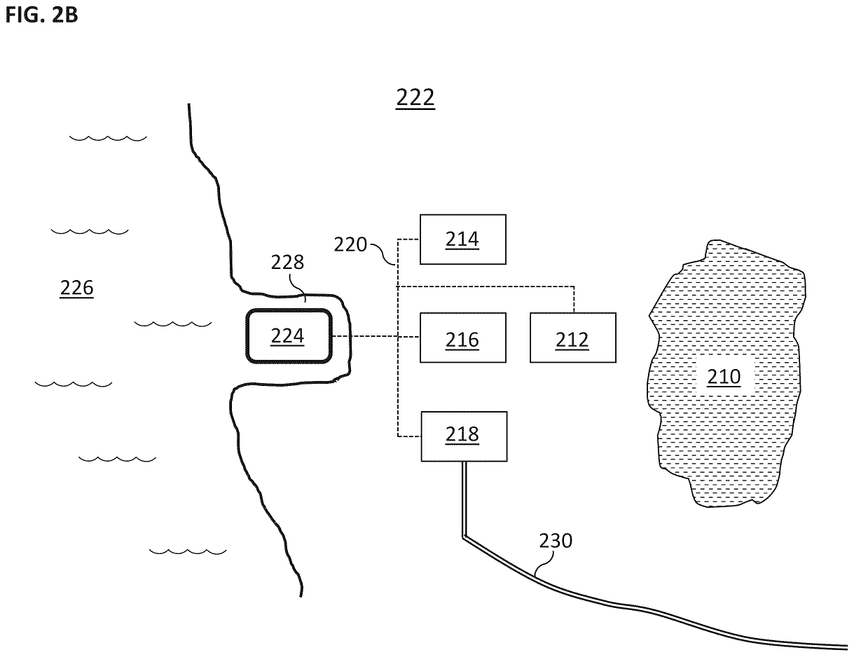

FIG. 2A is a top-down schematic depiction of portions of an illustrative industrial enterprise 200 at a remote inland location that comprises a TNPP 202 according to an illustrative embodiment of the invention. The enterprise 200 exemplifies one class of applications in which some embodiments of the invention are advantageous compared to the prior art of supplying energy in remote locations using diesel generators, which produce air pollution and require frequent deliveries of fuel at high cost. The installation 200 is accessible by a regional road 204 and local roads 206, 208. The installation 200 comprises a resource extraction area 210 (e.g., an open-pit mine), a first-stage processing facility 212, workers' quarters 214, an administration building 216, and a transfer station 218. All portions of the enterprise 200 that use energy such as but not limited to electrical power are supplied by the TNPP 202 through a local energy distribution system such as a microgrid 220, here represented as a network of dashed lines.

In the illustrated embodiment, the TNPP 202 is stationed on a prepared terrestrial site where it has been assembled from modular component parts delivered via truck along the regional road 204 and local road 206. When the TNPP 202 is decommissioned, the process of construction will be approximately reversed, and all components of the TNPP 202 will be removed along the roads by which they arrived, leaving a clean site that can ultimately be restored to a greenfield condition. Although denoted by a single rectangle in FIG. 2A, the TNPP 202 may comprise more than one structure, as, for example, a cluster of three buildings.

FIG. 2B is a top-down schematic depiction of portions of an illustrative industrial enterprise 222 at a coastal location that comprises a floating TNPP 224 according to another illustrative embodiment of the invention. Herein, “floating” refers to a structure that is either upheld buoyantly in a body of water or grounded within and substantially surrounded by a body of water.

Enterprise 222 is similar to enterprise 200 of FIG. 2A except that enterprise 222 is located near a large navigable water body 226. The installation 222 is accessible by a road 230 and, similar to installation 200 of FIG. 2A, comprises a resource extraction area 210 (e.g., an open-pit mine), a first-stage processing facility 212, workers' quarters 214, an administration building 216, and a transfer station 218. All portions of the enterprise 222 that use energy such as but not limited to electrical power are supplied by the TNPP 224 through a local energy distribution system such as a microgrid 220 (dashed lines).

The TNPP 224 is stationed within in a natural or artificial slip or harbor 228, having been assembled from modular parts in a shipyard qualified for the handling of nuclear materials and delivered to the enterprise 222 overwater, e.g., by towing. To decommission the TNPP 224, it will be returned overwater to its place of manufacture or to another facility qualified for the handling of nuclear materials, where the process of modular construction will be approximately reversed. Alternatively, the TNPP 224 may be decommissioned by modular disassembly at the site of the enterprise 222 and all components removed along the road 230.

In various other applications, a TNPP supplies some enterprise, settlement, or other energy consumer with thermal energy for structural heating, process heat, or the like, whether additionally or alternatively to the provision of electricity. There is no restriction to the provision of electricity.

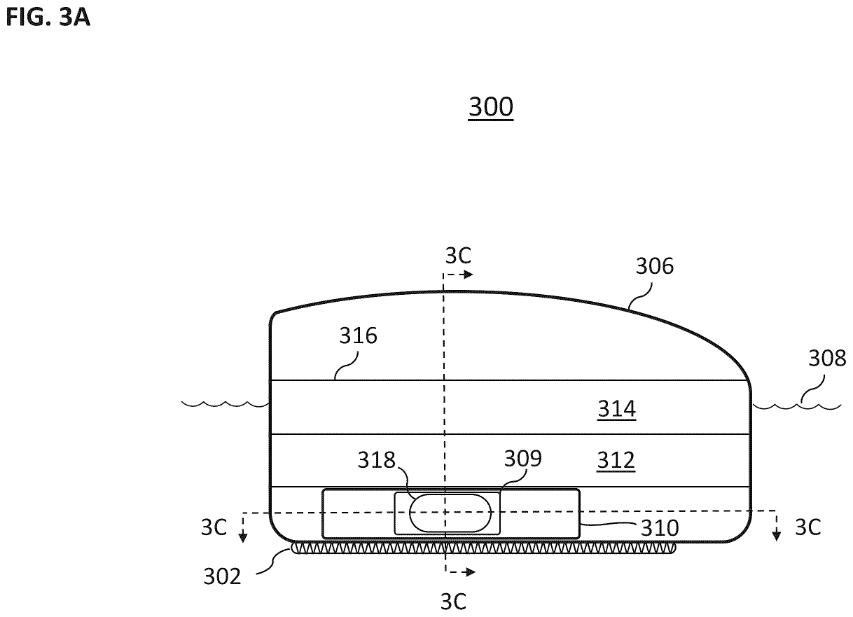

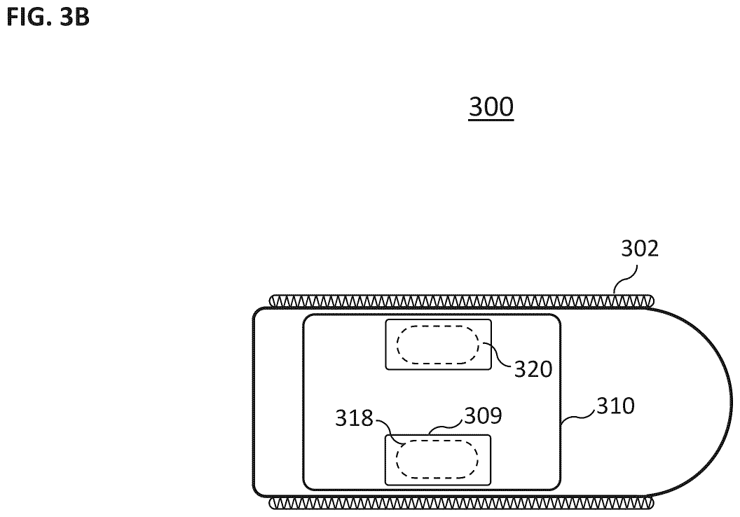

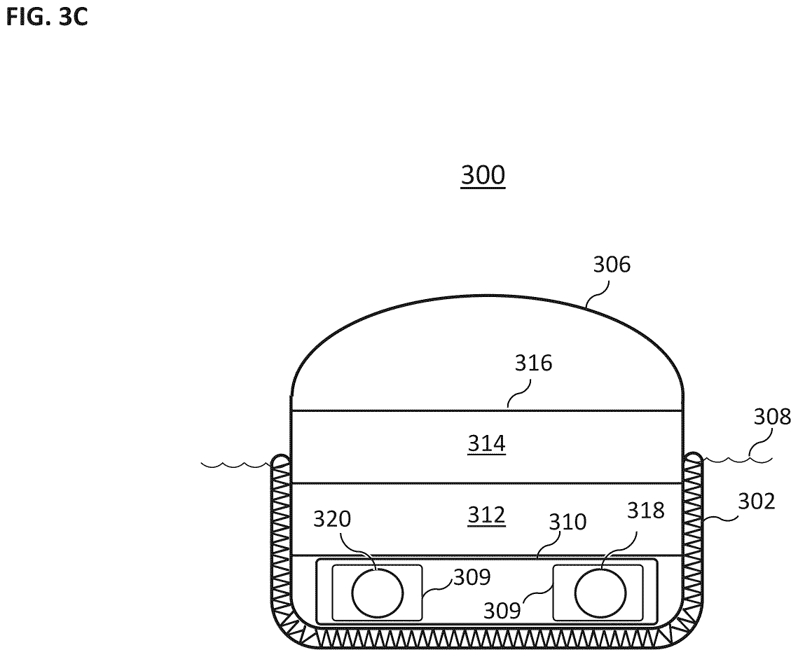

FIG. 3A schematically depicts portions of a floating TNPP 300 in vertical longitudinal cross-section according to an illustrative embodiment of the invention. FIG. 3B depicts the TNPP 300 in horizontal cross-section, with the view being defined by the broken line 3B-3B in FIG. 3A. FIG. 3C depicts the TNPP 300 in transverse cross-section, with the view being defined by the broken line 3C-3C in FIG. 3A.

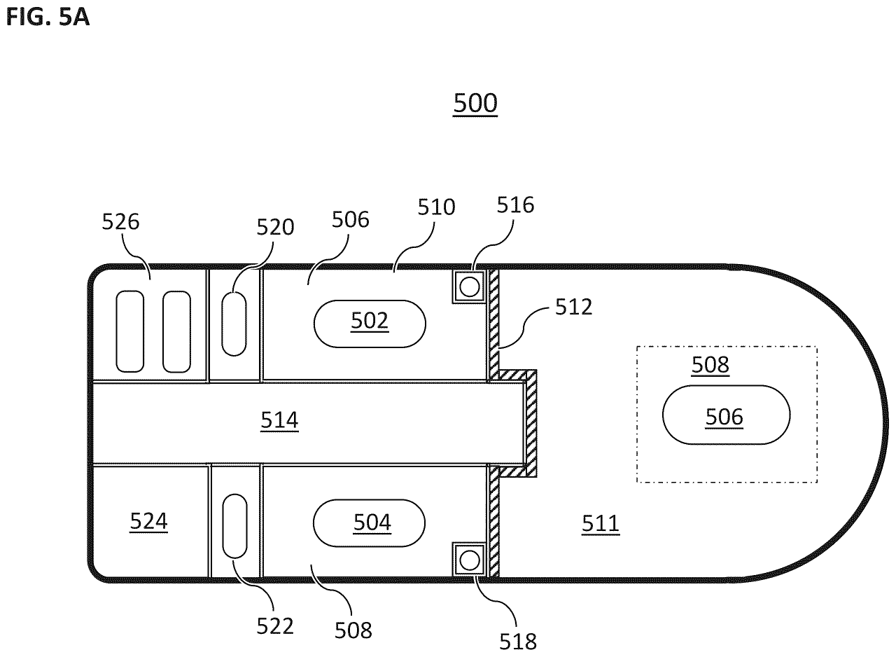

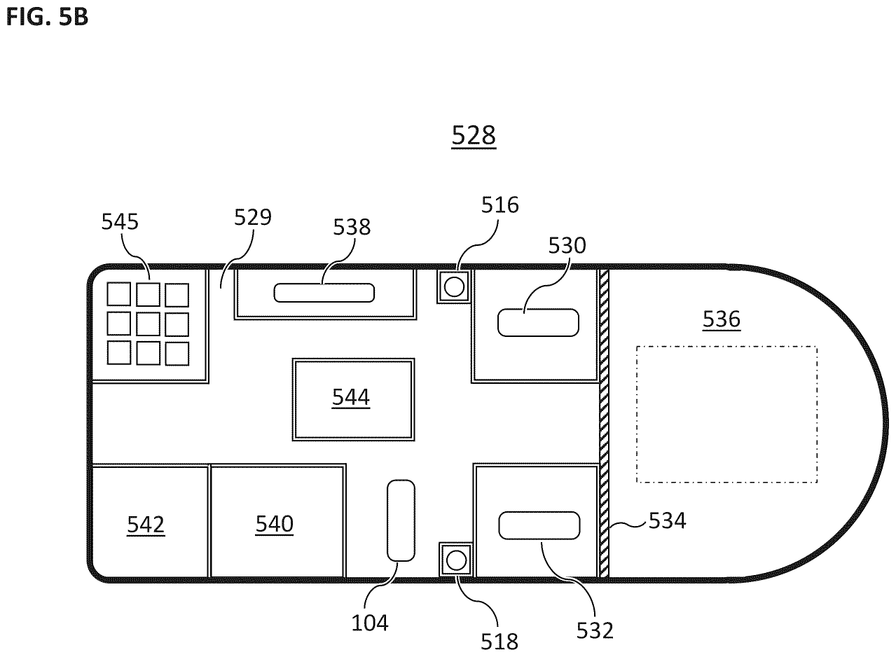

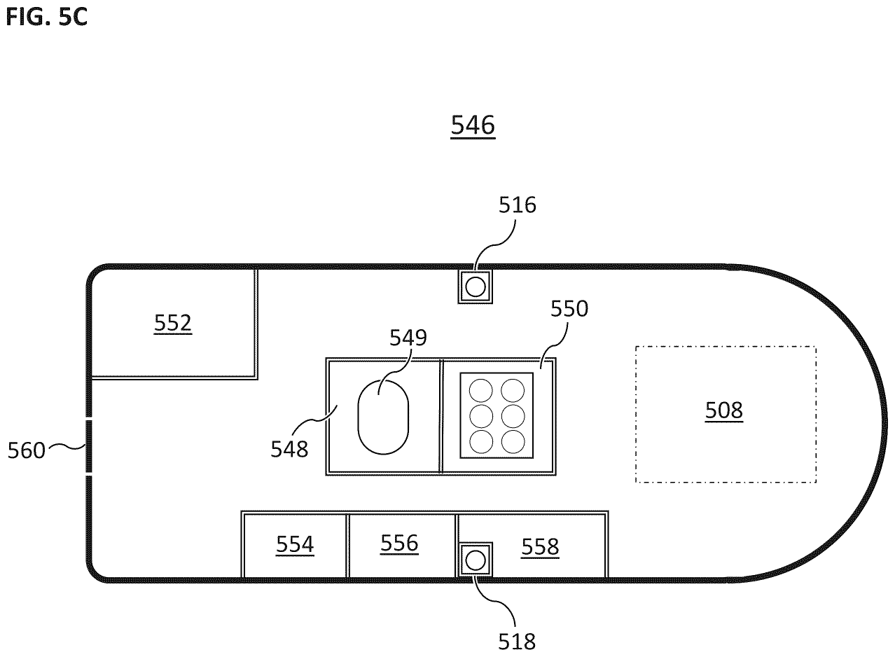

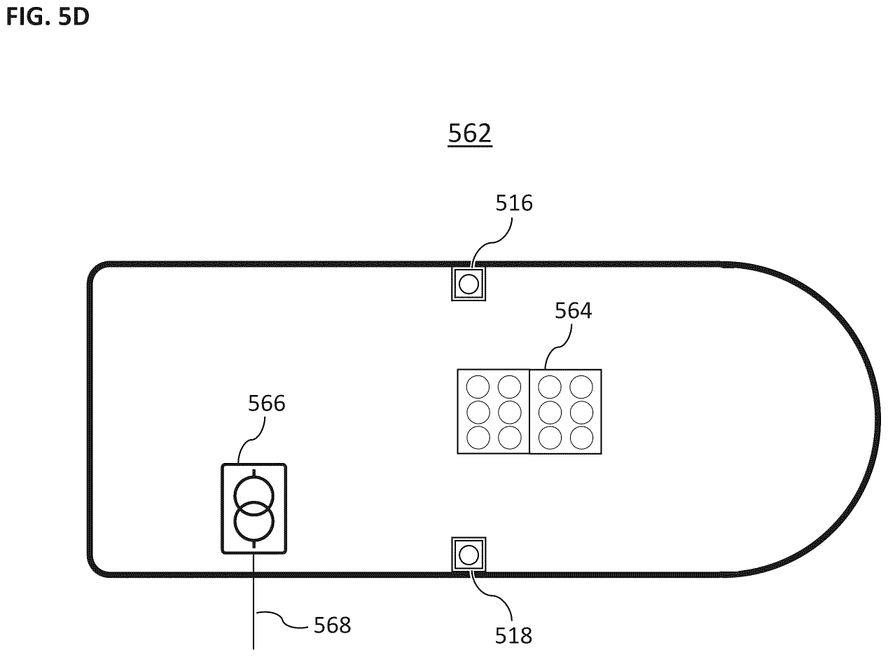

Referring now to FIG. 3A, the TNPP 300 comprises an outer barrier 302, one or more three-dimensionally layered protective structures, and a weather shield 306 and floats in a body of water 308. When stationed at a service location, the TNPP 300 may be grounded and/or may be secured in position by pilings, moorings, or other means. The TNPP 300 comprises a nuclear systems compartment 310, a conventional-process compartment 312, a support compartment 314, and an upper deck 316. Two reactors 318, 320 (only one of which is visible in FIG. 3A) are housed in the nuclear systems compartment 310. More details of the three compartments are depicted in FIGS. 5A-5D and discussed with reference thereto.

FIG. 3B is a schematic horizontal cross-sectional view of portions of the nuclear systems compartment 310 of TNPP 300. The nuclear systems compartment 310 is enclosed by the outer barrier 302, one or more three-dimensionally layered protective structures, housing two nuclear sub-compartments 309, each of which enclose SMR modules 318, 320.

FIG. 3C is a schematic transverse cross-sectional view of portions of the TNPP 300, depicting the outer barrier 302 enclosing the nuclear systems compartment 310, one or more three-dimensionally layered protective structures, housing two nuclear sub-compartments 309, each of which encloses one of the SMR modules 318, 320, the conventional-process compartment 312, the support systems compartment 314, the upper deck 316, and the weather shield 306.

It will be clear from FIGS. 3A-3C that the outer barrier of the TNPP 300 encloses the TNPP 300. The barrier 302 preferably comprises a crushable, energy-absorbing inner structure that is capable of supporting the successful mitigation of large external impacts such as those from crashing aircraft or collisions with vessels, heavy construction machinery, and the like. This barrier 302, combined with other nested barriers inside the TNPP 300, serves to ensure that key systems and components important to safety inside the nuclear and conventional-process compartments and sub-compartments 310, 312 of the TNPP 300 will perform their functions to the required level of reliability. The protective effect of the outer barrier 302 is enhanced by the shielding provided by the body of water 308. Because the primary purpose of the outer barrier 302 is mitigate the effects of a large impact on critical systems and components inside the TNPP 300, the design of the outer barrier 302 may vary over the surface of the TNPP 300 as depicted in the illustrative embodiment, to satisfy the design requirements. Since the support compartment 314 and other overlying portions of the TNPP 300 are not essential to the safe operation the SMRs 318, 320 or to the confinement or the containment of radioactive materials within the TNPP 300, these upper portions of the TNPP 300 are, for architectural purposes, considered impact-absorbing structures that contribute to layered defense-in-depth of the conventional-process compartment 312 and nuclear systems compartment 310. Moreover, the rounded form of the weather shield 306 not only tends to shed water, ice, and snow but wholly or partly deflects impacts from aircraft or other missiles. In various embodiments, the weather shield 306 is constituted substantially by an appropriately formed continuation of the outer barrier 302.

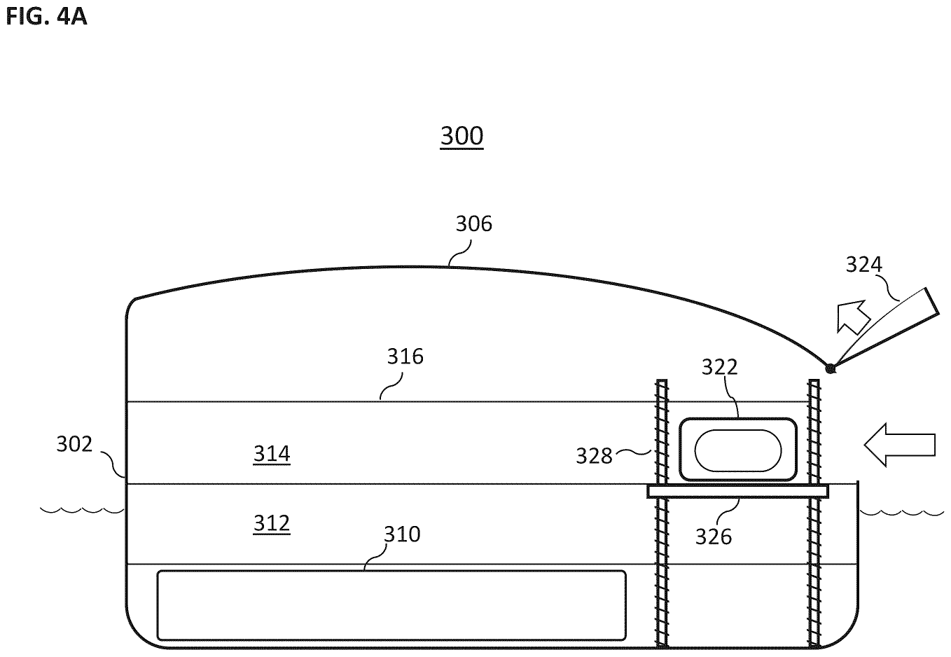

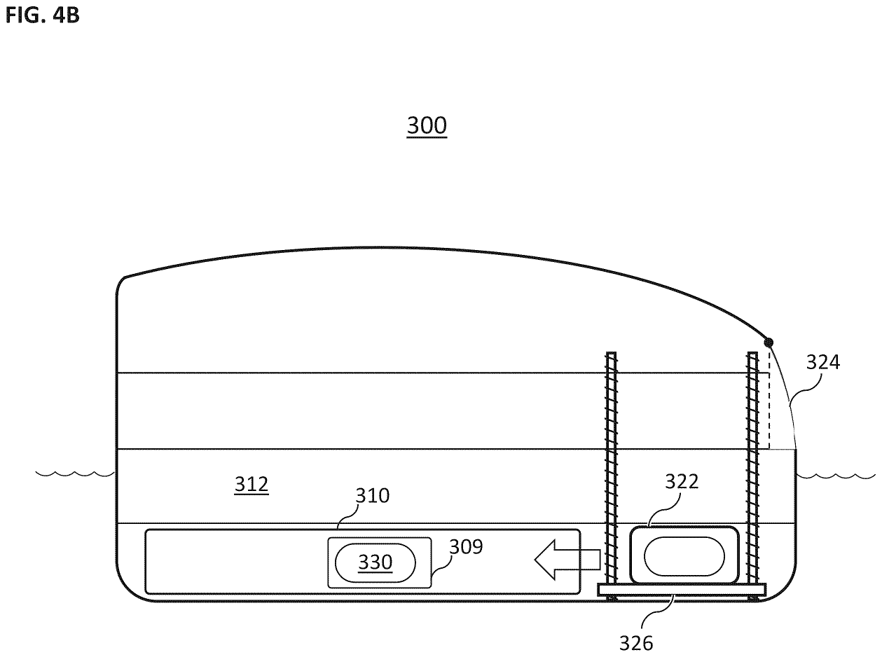

FIGS. 4A-4B depict portions of one process by which a SMR module 322 which, in this embodiment, is inside a transport package, can be delivered to and installed within the nuclear sub-compartment 309 within the nuclear system compartment 310 of the illustrative TNPP 300. This process also permits other equipment modules to be installed within their assigned sub-compartments in levels 312, 314, 316. FIG. 4A schematically depicts in longitudinal, vertical cross-section portions of the floating TNPP 300 of FIG. 3A during a first stage of the delivery of the SMR module 322 to the TNPP 300 as part of the first SMR module installation and commissioning process or to replace an SMR module 322. Prior to the stage of delivery depicted in FIG. 4A, the SMR module 322 is brought to the right-hand end of the TNPP 300 by a vessel (not depicted) or other transport medium. One or both of the TNPP 300 and the delivery medium are ballasted to align a ramp (not depicted) of the delivery vessel with the upper deck 316 of the TNPP 300. A section 324 of the outer barrier 302 is opened to provide admittance of the SMR module 322. The SMR module 322 is then transferred (e.g., upon heavy-duty machinery skates) from the delivery vessel to the upper deck 316. The TNPP 300 comprises a vertical transport system, e.g., a screw lift which in turn comprises a lift platform 326 and four screw columns (e.g., screw column 328). Vertically aligned openings in the three compartments, specifically, the mezzanines adjacent to 310, 312, 314, constitute a shaft through which the lift platform 326 can be raised and lowered. Use of a screw lift and supporting safety features integrated into the lift mechanisms practically eliminates the risk that a load on the lift platform 326 can fall due to a mechanical failure, in contrast to, for example, an elevator that relies upon cables that might break. In the state of operation depicted in FIG. 4A, the SMR module 322 has been placed upon the lift platform 326 in preparation for descent to the nuclear systems compartment 310.

FIG. 4B depicts a second stage of the delivery of the SMR module 322 to the TNPP 300. In the second stage, the section 324 of the outer barrier 302 has been closed and the SMR module 322 has been lowered to the level of the nuclear systems compartment 310. An arrow indicates that the SMR module 322 is then moved off the lift platform 326 to its assigned sub-compartment or, for temporary purposes other than operation, another location either in the nuclear systems compartment 310 or the adjacent mezzanine. Another SMR module 330 is already installed in its assigned sub-compartment 309. The SMR module 322 may be installed as delivered inside its own integral transport package or removed from the package and installed directly. Preferably, after removal of the SMR module 322 from the lift platform 326, the platform 326 is raised to the level of the floor of the conventional-process compartment 312 and reversibly sealed in place in order to contribute to the isolation of the interior of the nuclear systems compartment 310 from all other portions of the TNPP 300.

In another illustrative embodiment (not depicted), a TNPP similar to TNPP 300 of FIG. 4A is stationed on a terrestrial site (e.g., as in FIG. 2A). The configuration can be made to allow loading of the SMR module via either the level of the nuclear systems compartment or the support services compartment. For example, if the terrestrial site is inset into an excavated and stabilized pit for additional impact protection, an SMR module loading method similar to that of FIGS. 4A-4B may be employed, with the SMR module being delivered to the support systems compartment of the TNPP via a bridge from the pit perimeter and, thence, lowered by screw lift to the nuclear systems compartment. Alternatively, if the SMR module cannot be raised to the support systems level due to site conditions, the TNPP may comprise no screw lift and instead load SMR modules directly at the level of the nuclear systems compartment. These and other variations in SMR loading method are contemplated and within the scope of the invention, there being no restriction on entry of SMR modules at any particular point or level into the TNPP.

FIGS. 5A-5D schematically depict in horizontal cross-section the layout of portions of a TNPP 500 according to an illustrative embodiment of the invention similar to that depicted in FIGS. 3A-3B. Components, numbers of components, and layouts other than those depicted in FIGS. 5A-5D are contemplated and within the scope of the invention. FIG. 5A depicts portions of the layout of a nuclear systems compartment 510 of a TNPP 500 that comprises two SMRs 502, 504. A third SMR module 506 is depicted on the lift platform 508 of a screw lift, but is depicted only to illustrate spatial relationships. The two SMRs 502, 504 are contained in radiologically shielded, entry-resistant sub-compartments 506, 508. An SMR module delivered via screw lift to the nuclear systems compartment 510 is inspected, and otherwise prepared for service in a preparatory area 511. The preparatory area 511 is divided from the nuclear systems compartment 510 by a radiologically shielded, and fireproof barrier 512. The preparatory area 511 is normally clean of radiological hazards and serves as an equipment staging area for maintenance activities. However, it can be set up as a temporary radiological zone with provisions put in place to complete final decontamination and prepare equipment for removal from the nuclear systems compartment 510. During these specific but short-lived activities, some radiation hazards and levels of radiological contamination can be present but are managed to specified low levels to clear equipment and personnel from the nuclear systems compartment. The remainder of the nuclear systems compartment 510 constitutes a permanent radiological zone, in which radiation hazards are present commensurate with operation of nuclear systems and some radiological contamination is routinely anticipated but controlled. SMRs 502, 504, 506 and other equipment are moved through a central passage 514 of the active-radiological zone. In various embodiments, SMRs 502, 504, 506 are introduced into, and during decommissioning removed from, their reactor cells from any direction, without restriction.

Passage of personnel and equipment between all chambers depicted in FIGS. 5A-5D is enabled by closeable hatches or doors (not depicted, for simplicity). Preferably, leak-tight doors of the reactor sub-compartments 506, 508 remain sealed against entry throughout the operational life of the SMRs 502, 504 within the cells, to maintain a consistent and controlled reactor sub compartment atmosphere, minimize worker radiation exposure and to deter malicious interference. The fireproof barrier 512 prevents any fire that originates in the high-radiological zone from spreading through the screw-lift shaft to other levels of the TNPP 500, or fire that originates in other levels from spreading to the radiological zone; the fireproof barrier 512 is also leak-tight, except when one or more doors in the barrier are open, in order to maintain a consistent and controlled atmosphere inside the radiological zone, contain radiological contamination, either routine or accidental. Interlevel barriers (floors/ceilings) and any engineered penetrations are leak-tight and fireproof throughout the TNPP 500. A conventional elevator (not depicted) permits controlled and secure transfer of personnel and materials between the nuclear systems compartment 510 and other levels of the TNPP 500.

Best practices for safety and security features of nuclear facilities, such as will be familiar to persons acquainted with the design of such facilities, are embodied integrally throughout the illustrative TNPP 500. For example, emergency egress for personnel in the nuclear compartment 510 and other compartments of the TNPP 500 is provided by one or more stairwells and/or companionways (not depicted). All elevator shafts, stairwells, and companionways are equipped with closeable, fireproof, penetration-resistant barriers in order to enable isolation of the nuclear systems compartment 510 for a series of postulated events, as well as with security interlocks that allow personnel egress even when power has failed but disallow ingress without activation of interlocks by the control room (which is depicted in FIG. 5C).

The reactor sub compartments 506, 508 are further contained within an emergency heat removal system equipped with passive air convection stacks 516, 518. Heat is generated constantly by the reactors 502, 504 and must be removed to maintain the reactor within a set of specifications set by the SMR designer. In the course of normal operation of many SMR designs, this occurs through heat exchange between the reactors 502, 504 and secondary heat transport fluid SSCs such as steam generators 520, 522, which transfer heat to the conventional-process compartment (FIG. 5B), from whence heat energy not used for processes or converted to electricity is ultimately rejected to the environment. However, during accident conditions, it is required to have at least one alternate route for the disposal of excess heat. The air intakes and convection stacks 516, 518, which penetrate the levels above the nuclear compartment 510 and ultimately communicate with the atmosphere above the TNPP 500, enable heat removal by passive heat exchange and convection. Intakes have provisions to prevent blockages as well as control the flowrate of air into the Emergency Heat Removal System to prevent overcooling of the reactor sub compartment. The convection stacks 516, 518 are fireproof, equipped with appropriate contamination removal features such as high efficiency filters and separated with barriers from other TNPP compartments. This is done to prevent any residual radiological contamination that escapes from the reactor sub-compartment 510 into the Emergency Heat Removal system from reaching other TNPP compartments. The stacks 516, 518 have provisions to prevent blockages and can be sealed off to further mitigate uncontrolled radiological releases from the TNPP 500. Another emergency cooling method, which may be used additionally or alternatively to air convection, entails rejection of heat into the surrounding environment via a system of thermosiphons (all passive, two-phase systems), e.g., leveraging RVAC systems. Yet another emergency cooling method which may be used additionally to the before mentioned is controlled flooding of the reactor sub-compartments 506, 508 with gravity-fed coolant; this coolant is retained in a tank 549 depicted in FIG. 5C. For simplicity, piping to deliver emergency coolant is not depicted in the Figures. As a last resort (e.g., if the upper levels of the TNPP 500 have been heavily damaged by an aircraft impact, for example), heat will dissipate to the environment at a safe rate by conduction through the walls of the reactor sub-compartment 506, 508 and the outer walls of the nuclear compartment 510, although this is not preferable if the TNPP 500 rests on permafrost.

The nuclear systems compartment 510 also comprises workshops 524 where radiologically sensitive tests and procedures may be carried out, such as chemical monitoring of SMR SSC material conditions; and a storage area 526 for housing containerized low-to intermediate-level radioactive wastes (e.g., oils, filters). Preferably the nuclear systems compartment 510 and other compartments of the TNPP 500 contain all facilities, containers, instruments, reagants, and miscellaneous gear necessary for relatively long-term independent operation of the TNPP 500.

Moreover, the nuclear systems compartment 510 is served by an air-circulation and conditioning system (not depicted) that is separate from the air-handling systems serving other portions of the TNPP 500. That is, the nuclear compartment 510 has connections to atmospheric air that are separate and widely separated from those used by systems serving other portions of the TNPP 500. Filters on all air intakes and exhausts limit the passage of radioactive particles into and out of the TNPP 500 during postulated operating and accident states. A design principle employed throughout the TNPP 500 in various embodiments is multiple layers of inherent structural containment of radiological materials and robustness to damage from interior or exterior events, including accidents and malicious acts.

In FIGS. 5A-5D, all compartments and sub-compartments are preferably constructed in a discrete, modular manner that enables them to be transported by truck or another heavy-transport method from a place of manufacture to a place of TNPP assembly and there emplaced during manufacture. It is also preferable that all structural components of the TNPP 500, as for example the outer barrier, weather shield, and level dividers, be manufactured as numbers of in maximally similar, transportable subsections that can be transported to and assembled at a location of TNPP assembly. The location of TNPP assembly may be, for example, a qualified shipyard or the enterprise or community to be supplied by the TNPP 500 with power. It is also preferable that all compartments, sub-compartments and barriers comprised by the TNPP 500 be robust enough to serve, to a meaningful degree, as barriers to fire and mechanical penetration. The TNPP500, thus, architecturally encapsulates its mechanical and chemical components, including its radioactive components, in a nested set of barriers that inherently resist: (1) uncontrolled release of harmful substances and/or radioactive substances, fire, and other threats from compartments and sub-compartments, and (2) penetration of compartments and sub-compartments by accidents or malicious actions.

FIG. 5B depicts portions of the layout of a conventional-process compartment 528 of the TNPP 500. The conventional-process compartment 528 comprises power conversion equipment, e.g., turbine-generators 530, 532, each being powered by at least one of the reactors 502, 504 of FIG. 5A and housed in a separate sub-compartment. Fire and explosion-resistant compartmentalization throughout all TNPP compartments and sub-compartments reduces the risk that an explosion or fire starting in any area of the TNPP 500 will spread. A fire and smoke resistant, barrier 534 divides the bulk of the conventional-process compartment 528, identified as a conventional-process area 529, from the screw-lift shaft and landing area 536. The barrier 534 serves as an access control feature and prevents any residual contamination from the nuclear systems compartment 510 or equipment on the screw lift from entering the conventional-process compartment 528. The conventional-process compartment 528 is penetrated vertically by the emergency-cooling convection stacks 516, 518 and also comprises: (1) a water-purification skid 104 for the refinement (by, e.g., reverse osmosis or ion exchange) of pure water (for, e.g., steam generation, human use, emergency cooling) from a local water supply, salt or fresh, (2) auxiliary generator equipment 538, (3) a control room 540 for the SMRs and other aspects of the TNPP 500 (e.g., access interlocks), (4) a briefing and security room 542, and (5) an electrical enclosure 544 that contains electrical equipment (switchgear, etc.) necessary to the operation of the TNPP 500. The conventional-process compartment 528 and support systems compartment 546 (depicted in FIG. 5C) are served by independent air-handling systems. The conventional-process compartment 528 is also served by a self-contained emergency air supply (not depicted) capable, in this example, of supplying occupants' needs for at least 72 hours; an emergency high-reliability electrical power supply 545 (e.g., array of batteries or fuel cells) enabling the control room and other safety-critical systems to operate, in this example, for at least 72 hours; and provisions (not depicted) for directing excess process heat (e.g., left over from operation of power conversion equipment 530, 532) to the upper levels of the TNPP 500 and, thence, to the environment.

FIG. 5C depicts portions of the layout of a support compartment 546 of the TNPP 500, which houses the least critical functions of the TNPP 500. The support systems compartment 546 is penetrated vertically by the emergency-cooling convection intakes and stacks 516, 518 and also comprises: (1) a tank room 548 holding purified water and other fluids, (2) an HVAC room 550 containing fans and other equipment for transporting excess heat (e.g., from the conventional-process compartment) to the environment, (3) staff amenities facilities 552, and (4) a security facility and visitor-processing area 554, and administration rooms 556, 558. Except in emergencies or major equipment transfers, all visitors and personnel enter and exit the TNPP 500 through a main entrance 560 on this level. The lift platform 508 is depicted, since it is at the level of the conventional-process compartment 546 that reactor modules and other heavy equipment are transferred in and out of the TNPP 500 according to the illustrative method depicted in FIGS. 4A-4B. Coolant from the tank 549 in the tank room 548 can be gravity fed to the reactor sub-compartments 506, 508 of FIG. 5A for emergency cooling purposes.

FIG. 5D depicts portions of the layout of the upper deck 562 of the TNPP 500 (a.k.a., roof of the support compartment 546 of FIG. 5C). Air and heat exchange of the TNPP 500 with the environment occur on the upper deck 562; various penetrations of the overlying weather shield (not depicted in FIG. 5D) are typically also present in order to enable air exchange, electrical connections, and the like. The upper deck 562 is penetrated vertically by the emergency-heat removal system convection stacks 516, 518 and also comprises: (1) a heat-rejection island 564, through which heat from the routine operation of the TNPP 500 is finally rejected to the environment, and (2) a transformer array 566 through which the TNPP 500 supplies electrical power to a local microgrid or other consumer through transmission lines 568.

In various other embodiments than those depicted in the Figures, the compartments of the TNPP 500 are not stacked within a single vessel or structure but are distributed among two or more vessels or structures that float or stand in proximity to each other. There is no restriction to a vertical arrangement of all three compartments as depicted in, for example, FIGS. 3A-3C.

Systems for ventilation and general air flow are designed such that air flow always occurs from areas of low or no radiological contamination to higher areas of radiological contamination such that any contaminants can be directed through appropriate systems to reduce releases to acceptable levels.

Administrative measures can be put in place to designate the platform of the screw lift as a specific radiological zone as required by operational needs. The screws lift is designed to be readily decontaminated so that it can be moved from one radiological zone to another without transferring contamination.

The foregoing has been a detailed description of illustrative embodiments of the invention. Various modifications and additions can be made without departing from the spirit and scope of this invention. Each of the various embodiments described above may be combined with other embodiments in order to provide multiple features. Furthermore, while the foregoing describes a number of separate embodiments of the apparatus and method of the present invention, what has been described herein is merely illustrative of the application of the principles of the present invention. Accordingly, this description is meant to be taken only by way of example, and not to limit the scope of this invention.

1. A transportable nuclear power plant, comprising:
a housing;
an outer barrier, forming at least a first part of the housing;
a weather shield connected to the outer barrier, forming at least a second part of the housing;
a nuclear systems compartment defined within the housing, wherein the nuclear systems compartment is adapted to contain at least one small modular nuclear reactor;
a conventional-process compartment defined within the housing, wherein the conventional-process compartment is adapted to contain at least one power generator capable of converting energy from the at least one small modular nuclear reactor into electricity; and
a support compartment defined within the housing, wherein the support compartment is adapted to contain at least one system supportive of at least one of the small modular nuclear reactor and the power generator.

2. The transportable nuclear power plant of claim 1, wherein the first part of the housing is a bottom part of the housing.

3. The transportable nuclear power plant of claim 1, wherein the second part of the housing is a top part of the housing.

4. The transportable nuclear power plant of claim 1, further comprising:
an upper deck defined within the housing.

5. The transportable nuclear power plant of claim 1, further comprising:
an screw lift disposed within the housing,
wherein the nuclear systems compartment defines a first floor within the housing,
wherein conventional-process compartment defines a second floor within the housing above the first floor,
wherein the support compartment defines a third floor within the housing above the second floor, and
wherein the screw lift provides access to at least the first floor, the second floor, and the third floor.

6. The transportable nuclear power plant of claim 5, further comprising:
a nuclear compartment disposed on the first floor; and
a radiation barrier disposed on the first floor, separating the nuclear compartment from the screw lift.

7. The transportable nuclear power plant of claim 5, further comprising:
a nuclear compartment disposed on the first floor; and
a fire barrier disposed on the second floor, separating the conventional process area from the screw lift.

8. The transportable nuclear power plant of claim 1, wherein:
the housing is adapted to float on a body of water.

9. The transportable nuclear power plant of claim 1, wherein:
the housing is adapted to be grounded within a body of water.

10. The transportable nuclear power plant of claim 1, wherein:
the housing is adapted to be transported to a service site via at least one of truck, ship, or heavy-lift aircraft.

11. The transportable nuclear power plant of claim 1, wherein:
the housing is adapted to be assembled at a service site.

12. The transportable nuclear power plant of claim 1, wherein:
at least a portion of the outer barrier is crushable, forming an energy-absorbing structure adapted to mitigate a force from an external impact thereon.

13. The transportable nuclear power plant of claim 12, wherein:
the outer barrier comprises one or more energy-absorbing structures disposed on the housing, and
the outer barrier comprises at least a portion of at least one of the support compartment, the conventional-process compartment, and the weather shield.

14. The transportable nuclear power plant according to claim 1, further comprising:
an emergency heat removal system adapted to dispose of heat from the at least one small modular nuclear reactor during accident conditions.

15. The transportable nuclear power plant according to claim 1, wherein:
at least one of the nuclear systems compartment, the conventional-process compartment, the support compartment, and the weather shield are adapted to resist uncontrolled release of at least one of harmful substances, radioactive substances, and fire.
